(19) United States
(12) Patent Application Publication
(10) Pub. No.: US 2014/0162652 A1
(43) Pub. Date: Jun. 12, 2014

(54) SYSTEM AND METHOD FOR HANDOVER AND POWER CONTROL FOR WIRELESS COMMUNICATION OF HIGH-SPEED MOBILE

(71) Applicant: ELECTRONICS AND TELECOMMUNICATIONS RESEARCH INSTITUTE, Daejeon (KR)

(72) Inventors: Min Soo KANG, Daejeon (KR); Kwang Seon KIM, Daejeon (KR); Bong-Su KIM, Daejeon (KR); Woo Jin BYUN, Daejeon (KR)

(73) Assignee: ELECTRONICS AND TELECOMMUNICATIONS RESEARCH INSTITUTE, Daejeon (KR)

(21) Appl. No.: 13/949,605

(22) Filed: Jul. 24, 2013

(30) Foreign Application Priority Data
Dec. 11, 2012 (KR) 10-2012-0143537

(51) Int. Cl. H04W 36/32; H04W 52/28

(52) U.S. Cl. CPC H04W 36/32; H04W 52/285
USPC 455/436; 455/522

(57) ABSTRACT

Provided is a method for handover for wireless communication of a high-speed mobile. The method may include receiving, from a candidate communication base station able to communicate with the high-speed mobile, location information of the candidate communication base station and location information of a neighboring communication base station near the candidate communication base station, obtaining current location information and speed information of the high-speed mobile based on global positioning system (GPS) satellite information of the high-speed mobile and topographic information around the high-speed mobile, determining an optimal communication base station among the candidate communication base station and the neighboring communication base station, based on the location information of the candidate communication base station, the location information of the neighboring communication base station, the current location information of the high-speed mobile, and the speed information of the high-speed mobile, and executing handover to the optimal communication base station.

### CROSS-REFERENCE TO RELATED APPLICATION

This application claims the priority benefit of Korean Patent Application No. 10-2012-0143537, filed on Dec. 11, 2012, in the Korean Intellectual Property Office, the disclosure of which is incorporated herein by reference.

### BACKGROUND

1. Field of the Invention

The present invention relates to a system and method for handover and power control for wireless communication of a high-speed mobile, and more particularly, to a technique for handover and power control based on location information and speed information of a high-speed mobile.

2. Description of the Related Art

A handover technique for wireless communication of a high-speed mobile refers to a process of transferring communication control responsibility when the high-speed mobile moves from an area covered by one radio base station to another, to provide the high-speed mobile with continuous communication without loss or interruption of a service, and involves searching signals of neighboring radio base stations near a serving radio base station and selecting an available radio base station.

Also, a power control technique for wireless communication of a high-speed mobile refers to a process of controlling transmission power of the high-speed mobile in response to a control command being received from a communication base station communicating with the high-speed mobile, wherein the control command is used for controlling the transmission power of the high-speed mobile.

### SUMMARY

An aspect of the present invention provides a method, apparatus, and system for handover and power control for wireless communication of a high-speed mobile using location information and speed information based on a moving path of the high-speed mobile.

Another aspect of the present invention also provides a method, apparatus, and system for executing handover for wireless communication of a high-speed mobile by estimating future location information of the high-speed mobile.

Still another aspect of the present invention also provides a method, apparatus, and system for using data resulting from handover executed based on a moving path of a high-speed mobile in the handover for wireless communication of the high-speed mobile.

Yet another aspect of the present invention also provides a method, apparatus, and system for executing power control for wireless communication of a high-speed mobile by estimating a change in transmission power with the movement of the high-speed mobile.

Further another aspect of the present invention also provides a method, apparatus, and system for using data resulting from power control executed based on a moving path of a high-speed mobile in the power control for wireless communication of the high-speed mobile.

According to an aspect of the present invention, there is provided a method for handover for wireless communication of a high-speed mobile, the method including receiving, from a candidate communication base station able to communicate with the high-speed mobile, location information of the candidate communication base station and location information of a neighboring communication base station near the candidate communication base station, obtaining current location information and speed information of the high-speed mobile based on global positioning system (GPS) satellite information of the high-speed mobile and topographic information around the high-speed mobile, determining an optimal communication base station among the candidate communication base station and the neighboring communication base station, based on the location information of the candidate communication base station, the location information of the neighboring communication base station, the current location information of the high-speed mobile, and the speed information of the high-speed mobile, and executing handover to the optimal communication base station.

The determining of the optimal communication base station may include estimating future location information of the high-speed mobile based on the current location information and the speed information of the high-speed mobile, and determining the optimal communication base station among the candidate communication base station and the neighboring communication base station, based on the location information of the candidate communication base station, the location information of the neighboring communication base station, and the future location information of the high-speed mobile.

The method may further include extracting a candidate communication base station able to communicate with the high-speed mobile among a plurality of communication base stations near the high-speed mobile.

The extracting of the candidate communication base station may include estimating the candidate communication base station among the plurality of communication base stations, using the speed information of the high-speed mobile and the topographic information around the high-speed mobile in a direction in which the high-speed mobile intends to move.

The method may further include storing data resulting from the handover executed based on a moving path of the high-speed mobile, and the determining of the optimal communication base station may further include determining the optimal communication base station among the candidate communication base station and the neighboring communication base station based on the result data.

According to another aspect of the present invention, there is provided a method for power control for wireless communication of a high-speed mobile, the method including receiving, from a communication base station communicating with the high-speed mobile, location information of the communication base station, obtaining location information and speed information of the high-speed mobile based on GPS satellite information of the high-speed mobile and topographic information around the high-speed mobile, calculating a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile, determining a transmission power and an antenna beam pattern of the high-speed mobile based on a result of the calculation, and controlling a transmission power to be radiated to the communication base station based on the determined transmission power and the determined antenna beam pattern.

The method may further include estimating a change in the transmission power with the movement of the high-speed mobile using the speed information of the high-speed mobile and the topologic information around the high-speed mobile in a direction in which the high-speed mobile intends to move.

The method may further include storing data resulting from the control of the transmission power executed based on a moving path of the high-speed mobile, and the determining may further include determining the transmission power and the antenna beam pattern of the high-speed mobile based on the result data.

The determining may include determining the transmission power and the antenna beam pattern of the high-speed mobile to maintain a constant level of received power being received at the communication base station, and the received power may be dependent on at least one of the location information of the communication base station, the location information of the high-speed mobile, the speed information of the high-speed mobile, and the topologic information around the high-speed mobile.

According to still another aspect of the present invention, there is provided a system for handover for wireless communication of a high-speed mobile, the system including a receiving unit to receive, from a candidate communication base station able to communicate with the high-speed mobile, location information of the candidate communication base station and location information of a neighboring communication base station near the candidate communication base station, an obtaining unit to obtain current location information and speed information of the high-speed mobile based on GPS satellite information of the high-speed mobile and topographic information around the high-speed mobile, a determination unit to determine an optimal communication base station among the candidate communication base station and the neighboring communication base station, based on the location information of the candidate communication base station, the location information of the neighboring communication base station, the current location information of the high-speed mobile, and the speed information of the high-speed mobile, and an execution unit to execute handover to the optimal communication base station.

The determination unit may include an estimation unit to estimate future location information of the high-speed mobile based on the current location information and the speed information of the high-speed mobile, and the determination unit may determine the optimal communication base station among the candidate communication base station and the neighboring communication base station, based on the location information of the candidate communication base station, the location information of the neighboring communication base station, and the future location information of the high-speed mobile.

The determination unit may further include a storage unit to store data resulting from the handover executed based on a moving path of the high-speed mobile, and the determination unit may determine the optimal communication base station among the candidate communication base station and the neighboring communication base station based on the result data stored in the storage unit.

According to yet another aspect of the present invention, there is provided a system for power control for wireless communication of a high-speed mobile, the system including a receiving unit to receive, from a communication base station communicating with the high-speed mobile, location information of the communication base station, an obtaining unit to obtain location information and speed information of the high-speed mobile based on GPS satellite information of the high-speed mobile and topographic information around the high-speed mobile, a calculation unit to calculate a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile, a determination unit to determine a transmission power and an antenna beam pattern of the high-speed mobile based on a result of the calculation, and a control unit to control a transmission power to be radiated to the communication base station based on the determined transmission power and the determined antenna beam pattern.

The system may further include an estimation unit to estimate a change in the transmission power with the movement of the high-speed mobile using the speed information of the high-speed mobile and the topologic information around the high-speed mobile in a direction in which the high-speed mobile intends to move.

The determination unit may further include a storage unit to store data resulting from the control of the transmission power executed based on a moving path of the high-speed mobile, and the determination unit may determine the transmission power and the antenna beam pattern of the high-speed mobile based on the result data stored in the storage unit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a handover system for wireless communication of a high-speed mobile according to an exemplary embodiment;

FIG. 2 is a flowchart illustrating a handover method for wireless communication of a high-speed mobile according to an exemplary embodiment;

FIG. 3 is a diagram illustrating a power control system for wireless communication of a high-speed mobile according to an exemplary embodiment;

FIG. 4 is a diagram illustrating an example of determining an antenna beam pattern of a high-speed mobile based on a distance from a communication base station according to an exemplary embodiment;

FIG. 5 is a diagram illustrating an example of determining an antenna beam pattern of a high-speed mobile based on topographic information around the high-speed mobile and location information of the high-speed mobile according to an exemplary embodiment;

FIG. 6 is a flowchart illustrating a power control method for wireless communication of a high-speed mobile according to an exemplary embodiment;

FIG. 7 is a block diagram illustrating a configuration of a handover system for wireless communication of a high-speed mobile according to an exemplary embodiment; and

FIG. 8 is a block diagram illustrating a configuration of a power control system for wireless communication of a high-speed mobile according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

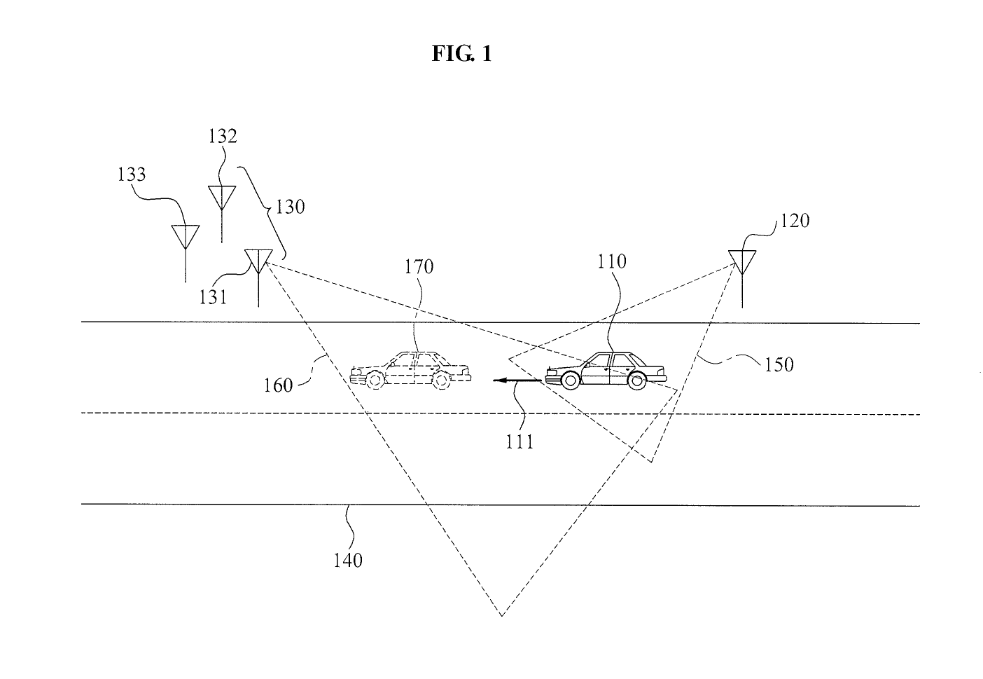

FIG. 1 is a diagram illustrating a handover system for wireless communication of a high-speed mobile according to an exemplary embodiment.

Referring to FIG. 1, the handover system may include a high-speed mobile 110, a highway 140 along which the high-speed mobile 110 travels, a serving communication base station 120, and a plurality of communication base stations 130. For example, the high-speed mobile 110 may include a high-speed group mobile such as a high-speed train, for example, Korea Train eXpress (KTX), an express bus, and the like. A moving speed of the high-speed mobile 110 may range from 100 kilometers per hour (Km/H) to 400 Km/H, however may include a speed less than 100 Km/H and a speed more than 400 Km/H.

The serving communication base station 120 and the plurality of communication base stations 130 may communicate with the high-speed mobile 110. The serving communication base station 120 may provide a coverage area 150 for communication with the high-speed mobile 110, and the plurality of communication base stations 130 may provide a coverage area 160 for communication with the high-speed mobile 110. The wireless communication between the high-speed mobile 110 and the serving communication base station 120 and the wireless communication between the high-speed mobile 110 and the plurality of communication base stations 130 may guarantee a line of sight (LoS) environment, and characteristics of wireless communication propagation may include a wireless propagation environment with minimized multipath fading.

When the high-speed mobile 110 moves in a left direction from the serving communication base station 120, the high-speed mobile 110 may get outside the coverage area 150 of the serving communication base station 120. To execute handover, one of the plurality of communication base stations 130 may be set to be an available communication base station for handover. The high-speed mobile 110 may search for a candidate communication base station 131 covering the coverage area 160 among the plurality of communication base stations 130.

The high-speed mobile 110 may receive, from the candidate communication base station 131, location information of the candidate communication base station 131 and location information of neighboring communication base stations 132 and 133 near the candidate communication base station 131. The high-speed mobile 110 may obtain current location information and speed information of the high-speed mobile 110 by employing a topographic information system of the high-speed mobile 110 and a location-based system using global positioning system (GPS) satellite information.

The handover system according to an exemplary embodiment may conduct a handover by determining an optimal communication base station among the candidate communication base station 131 and the neighboring communication base stations 132 and 133, based on the location information of the candidate communication base station 131, the location information of the neighboring communication base stations 132 and 133, the current location information of the high-speed mobile 110, and the speed information of the high-speed mobile 110. The handover process may be performed by estimating future location information 170 of the high-speed mobile 110 based on the current location information and the speed information of the high-speed mobile 110.

When the future location information 170 of the high-speed mobile 110 is estimated based on the current location information and the speed information of the high-speed mobile 110 obtained by employing the topographic information system of the high-speed mobile 110 and the location-based system using GPS satellite information, whether the future location information 170 of the high-speed mobile 110 is included in coverage areas of the neighboring communication base stations 132 and 133 and the coverage area 160 of the candidate communication base station 131 may be determined. Subsequently, the candidate communication base station 131 may be determined to be an optimal communication base station.

In the searching for the candidate communication base station 131 providing the coverage area 160 for communication with the high-speed mobile 110 among the plurality of communication base stations 130, the candidate communication base station 131 may be estimated and extracted among the plurality of communication base stations 130 using the speed information of the high-speed mobile 110 and the topographic information around the high-speed mobile 110 in a direction 111 in which the high-speed mobile 110 intends to move.

Further, when the high-speed mobile 110 moves regularly along a predetermined path 140, data resulting from the handover may be stored, evaluated, and fed back to the handover process. The data resulting from execution of the handover process may be reflected on a handover process that may be performed when the high-speed mobile 110 makes a next movement. For example, when the high-speed mobile 110 moves regularly along the predetermined path 140, the handover process may be performed based on data resulting from the handover process executed previously that is stored.

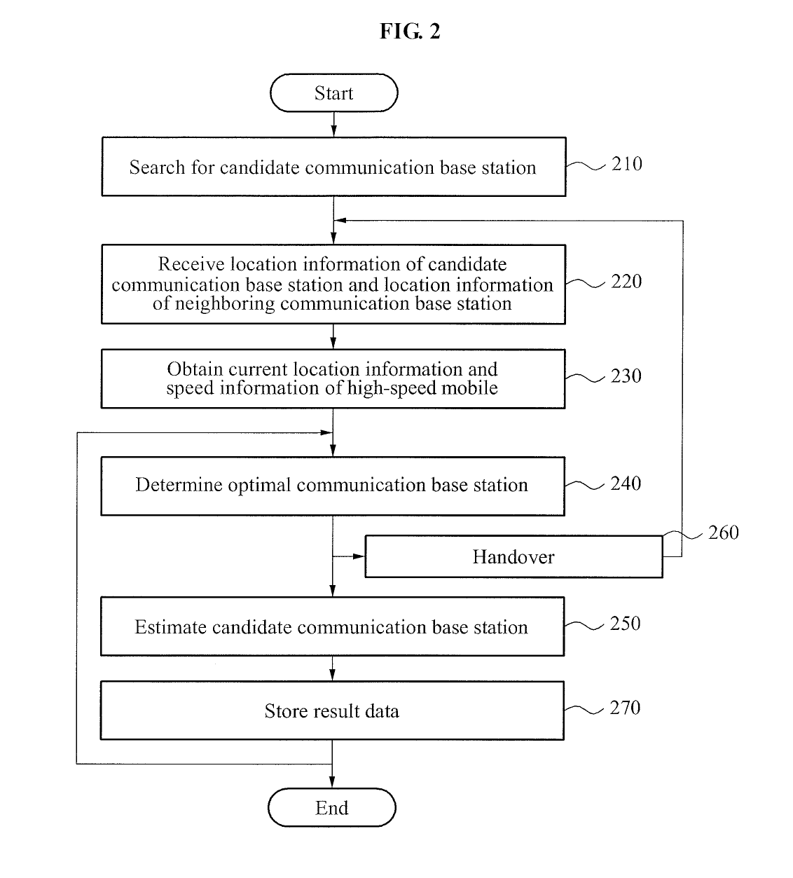

FIG. 2 is a flowchart illustrating a handover method for wireless communication of a high-speed mobile according to an exemplary embodiment.

Referring to FIG. 2, in operation 210, the handover system according to an exemplary embodiment may search for a candidate communication base station able to communicate with the high-speed mobile. The searching for the candidate communication base station may correspond to extracting a candidate communication base station able to communicate with the high-speed mobile among a plurality of communication base stations. The extracting of the candidate communication base station may include estimating a candidate communication base station among a plurality of communication base stations, using speed information of the high-speed mobile and topographic information around the high-speed mobile in a direction in which the high-speed mobile intends to move.

In operation 220, the handover system according to an exemplary embodiment may receive, from the candidate communication base station able to communicate with the high-speed mobile, location information of the candidate communication base station and location information of a neighboring communication base station near the candidate communication base station.

In operation 230, the handover system according to an exemplary embodiment may obtain current location information and speed information of the high-speed mobile based on GPS satellite information of the high-speed mobile and topologic information around the high-speed mobile.

In operation 240, the handover system according to an exemplary embodiment may determine an optimal communication base station among the candidate communication base station and the neighboring communication base station, based on the location information of the candidate communication base station, the location information of the neighboring communication base station, the current location information of the high-speed mobile, and the speed information of the high-speed mobile. The handover system according to an exemplary embodiment may estimate future location information of the high-speed mobile using the current location information and the speed information of the high-speed mobile, and may determine an optimal communication base station among the candidate communication base station and the neighboring communication base station, based on the location information of the candidate communication base station, the location information of the neighboring communication base station, and the estimated future location information of the high-speed mobile.

In operation 250, the handover system according to an exemplary embodiment may execute handover to the optimal communication base station.

In operation 260, the handover system may estimate the candidate communication base station among the plurality of communication base stations, using the speed information of the high-speed mobile and the topographic information around the high-speed mobile in a direction in which the high-speed mobile intends to move.

In operation 270, the handover system according to an exemplary embodiment may store data resulting from the handover executed based on a moving path of the high-speed mobile. The stored result data may be used to determine an optimal communication base station among the candidate communication base station and the neighboring communication base station.

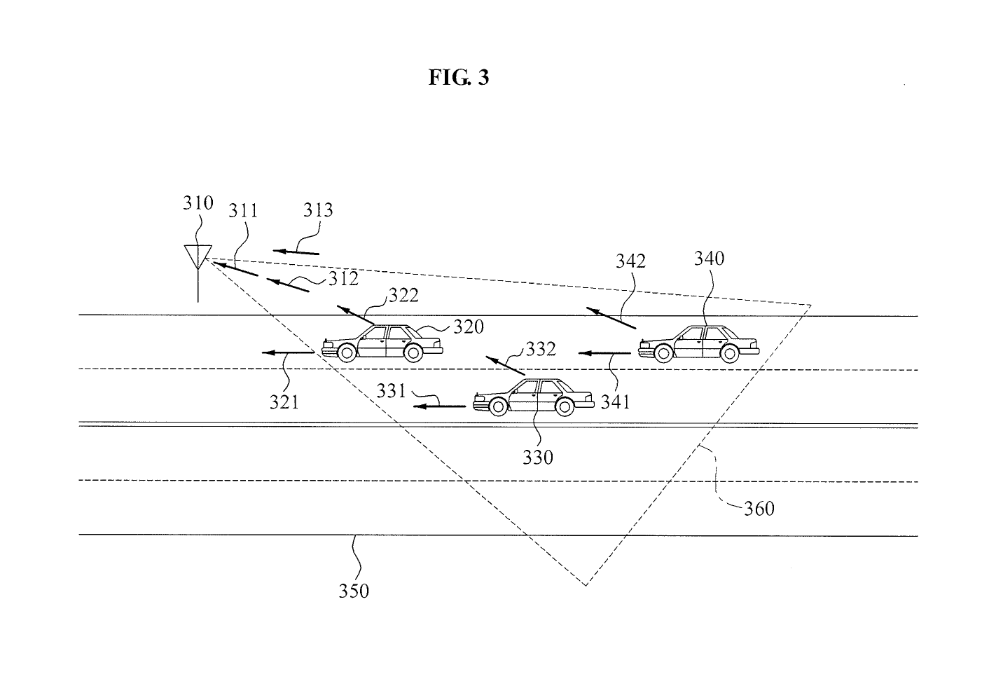

FIG. 3 is a diagram illustrating a power control system for wireless communication of a high-speed mobile according to an exemplary embodiment.

Referring to FIG. 3, the power control system may include a plurality of high-speed mobiles 320, 330, and 340, a communication base station 310 communicating with the plurality of high-speed mobiles 320, 330, and 340, and a highway 350 along which the plurality of high-speed mobiles 320, 330, and 340 travel. The plurality of high-speed mobiles 320, 330, and 340 may include a first high-speed mobile 320, a second high-speed mobile 330, and a third high-speed mobile 340. The plurality of high-speed mobiles 320, 330, and 340 may move in left directions 321, 331, and 341, respectively. The communication base station 310 may provide a coverage area 360 for communication with the plurality of high-speed mobiles 320, 330, and 340, and may be in communication with the plurality of high-speed mobiles 320, 330, and 340.

Received power 311, 312, and 313 being received at the communication base station 310 from the plurality of high-speed mobiles 320, 330, and 340 may be maintained at a constant level. To maintain a constant level of received power 311 from the first high-speed mobile 320, a constant level of received power 312 from the second high-speed mobile 330, and a constant level of received power 313 from the third high-speed mobile 340, transmission power 322, 332, and 342 and antenna beam patterns of the plurality of high-speed mobiles 320, 330, and 340 may be determined and controlled. The received power 311, 312, and 313 being received at the communication base station 310 may be dependent on at least one of location information of the communication base station 310, location information of each of the plurality of high-speed mobiles 320, 330, and 340, speed information of each of the plurality of high-speed mobiles 320, 330, and 340, and topologic information around each of the plurality of high-speed mobiles 320, 330, and 340.

For example, the first high-speed mobile 320 may receive location information of the communication base station 310 from the communication base station 310 communicating with the first high-speed mobile 320, and may obtain location information and speed information of the first high-speed mobile 320 by employing a topographic information system of the first high-speed mobile 320 and a location-based system using GPS satellite information. The first high-speed mobile 320 may calculate a distance between the communication base station 310 and the first high-speed mobile 320 and a direction from the first high-speed mobile 320 to the communication base station 310, based on the location information of the communication base station 310, the location information of the first high-speed mobile 320, the speed information of the first high-speed mobile 320, and the topologic information around the first high-speed mobile 320, and may determine a first transmission power 322 and an antenna beam pattern of the first high-speed mobile 320 based on a result of the calculation. The first transmission power 322 to be radiated from the first high-speed mobile 320 to the communication base station 310 may be determined based on the determined the first transmission power 322 and the determined antenna beam pattern of the first high-speed mobile 320.

Also, a change in the first transmission power 322 with the movement of the first high-speed mobile 320 may be estimated using the speed information of the first high-speed mobile 320 and the topologic information around the first high-speed mobile 320 in a direction 321 in which the first high-speed mobile 320 intends to move.

Further, when the first high-speed mobile 320 moves regularly along a predetermined path 350, data resulting from the control of the first transmission power 322 may be stored, evaluated, and fed back to the power control process. The data resulting from execution of the power control process may be reflected on a power control process that may be performed when the first high-speed mobile 320 makes a next movement. For example, when the first high-speed mobile 320 moves regularly along the predetermined path 350, the power control process may be performed based on data resulting from the power control process executed previously that is stored.

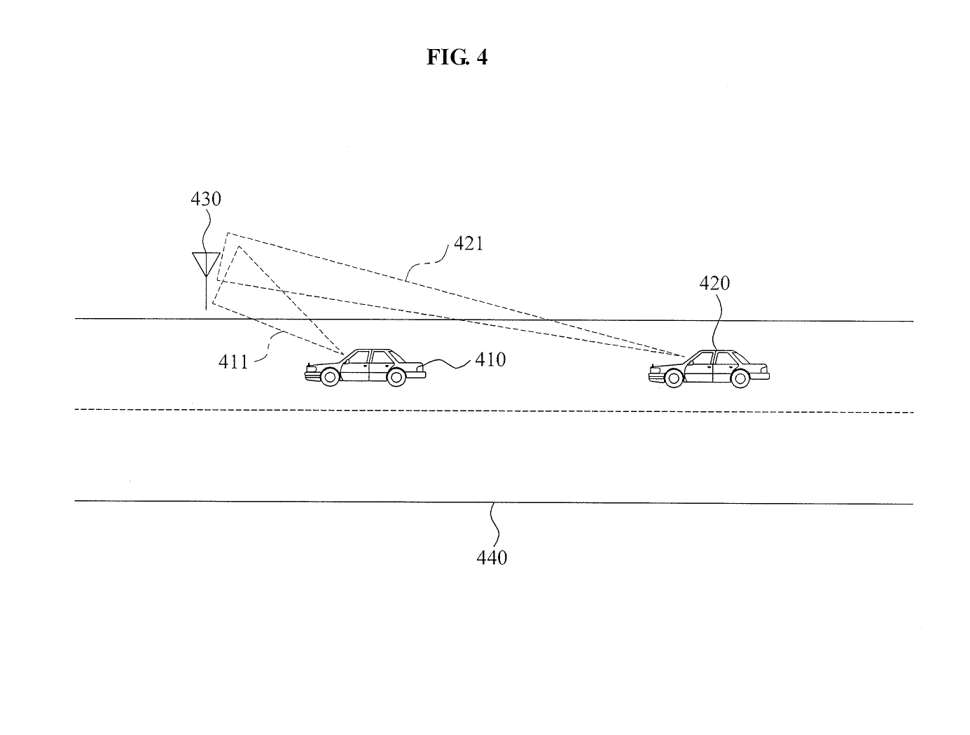

FIG. 4 is a diagram illustrating an example of determining an antenna beam pattern of a high-speed mobile based on a distance from a communication base station according to an exemplary embodiment.

Referring to FIG. 4, provided may be a plurality of high-speed mobiles 410 and 420, a communication base station 430 communicating with the plurality of high-speed mobiles 410 and 420, and a highway 440 along which the plurality of high-speed mobiles 410 and 420 travel. The plurality of high-speed mobiles 410 and 420 may include a first high-speed mobile 410 and a second high-speed mobile 420. The plurality of high-speed mobiles 410 and 420 may move in a left direction. A distance between the first high-speed mobile 410 and the communication base station 430 may be shorter than a distance between the second high-speed mobile 420 and the communication base station 430.

In a case in which the distance between the second high-speed mobile 420 and the communication base station 430 is long, an antenna beam pattern 421 of the second high-speed mobile 420 may be determined to increase an antenna gain of the second high-speed mobile 420.

In a case in which the distance between the first high-speed mobile 410 and the communication base station 430 is short, an antenna beam pattern 411 of the first high-speed mobile 410 may be determined to decrease an antenna gain of the first high-speed mobile 410.

In this example, a criterion for a short or long distance between the second high-speed mobile 420 and the communication base station 430 and between the first high-speed mobile 410 and the communication base station 430 may be relative.

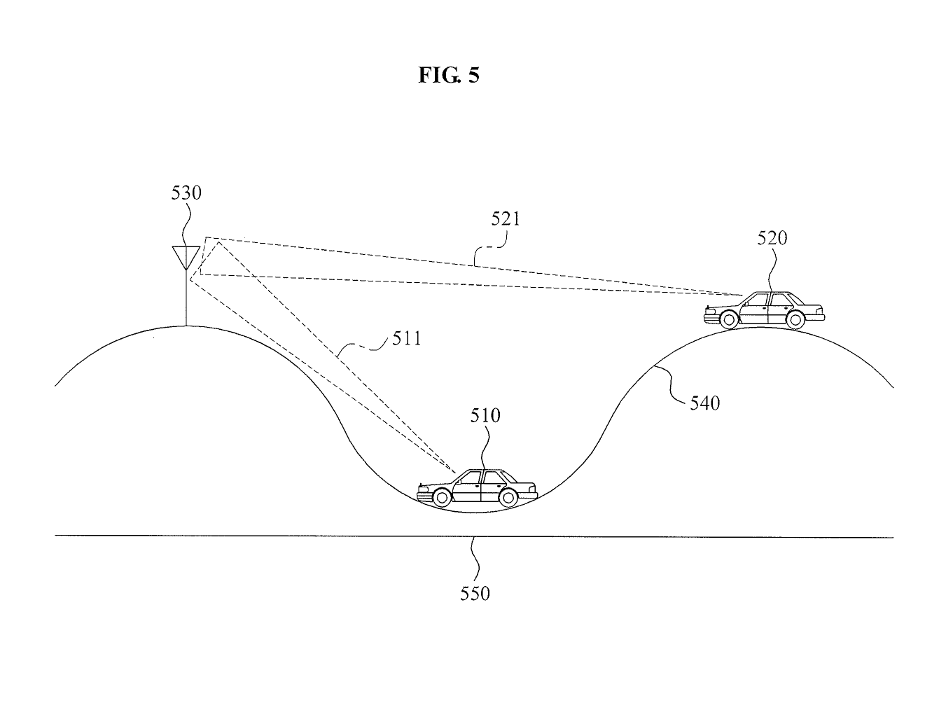

FIG. 5 is a diagram illustrating an example of determining an antenna beam pattern of a high-speed mobile based on topographic information around the high-speed mobile and location information of the high-speed mobile according to an exemplary embodiment.

Referring to FIG. 5, provided may be a plurality of high-speed mobiles 510 and 520, a communication base station 530 communicating with the plurality of high-speed mobiles 510 and 520, and a highway 540 along which the plurality of high-speed mobiles 510 and 520 travel. The plurality of high-speed mobiles 510 and 520 may include a first high-speed mobile 510 and a second high-speed mobile 520. The plurality of high-speed mobiles 510 and 520 may move in a left direction. The highway 540 along which the plurality of high-speed mobiles 510 and 520 travel may have a varying height above sea level 550.

The first high-speed mobile 510 may determine an antenna beam pattern 511 of the first high-speed mobile 510 based on location information of the first high-speed mobile 510, topologic information around the first high-speed mobile 510, and a distance between the first high-speed mobile 510 and the communication base station 530.

The second high-speed mobile 520 may determine an antenna beam pattern 521 of the second high-speed mobile 520 based on location information of the second high-speed mobile 520, topologic information around the second high-speed mobile 520, and a distance between the second high-speed mobile 520 and the communication base station 530.

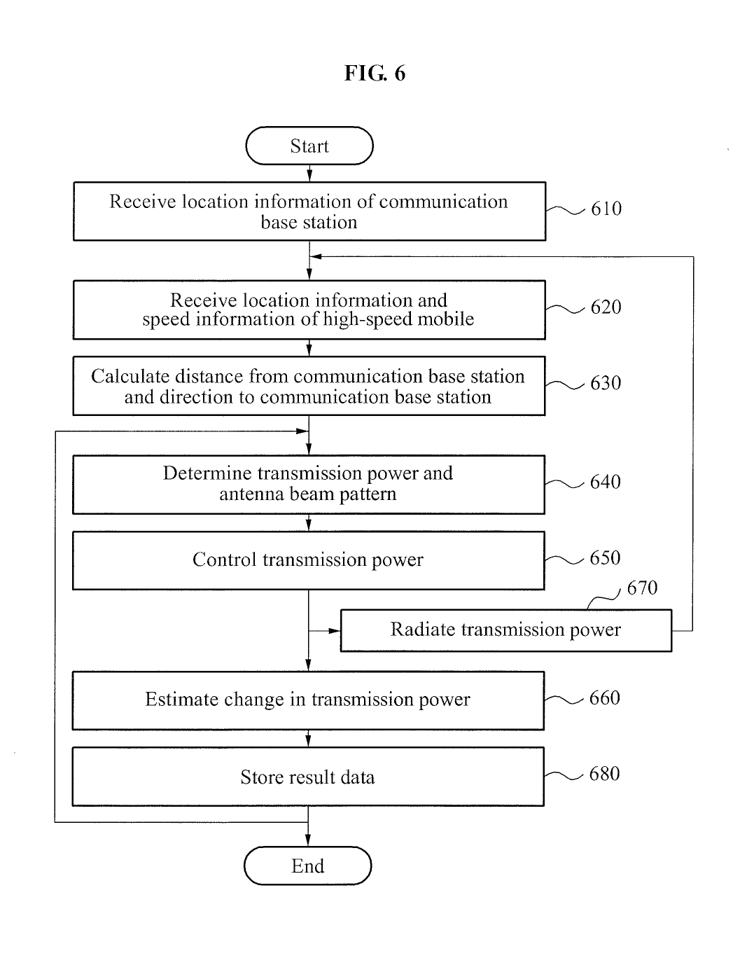

FIG. 6 is a flowchart illustrating a power control method for wireless communication of a high-speed mobile according to an exemplary embodiment.

Referring to FIG. 6, in operation 610, the power control system according to an exemplary embodiment may receive location information of a communication base station from the communication base station communicating with a high-speed mobile.

In operation 620, the power control system according to an exemplary embodiment may obtain location information and speed information of the high-speed mobile based on GPS satellite information of the high-speed mobile and topographic information around the high-speed mobile.

In operation 630, the power control system according to an exemplary embodiment may calculate a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile.

In operation 640, the power control system according to an exemplary embodiment may determine a transmission power and an antenna beam pattern of the high-speed mobile based on a result of the calculation.

In operation 650, the power control system according to an exemplary embodiment may control a transmission power to be radiated to the communication base station based on the determined transmission power and the determined antenna beam pattern. In operation 670, a change in the transmission power with the movement of the first high-speed mobile 320 may be estimated using the speed information of the high-speed mobile and the topologic information around the high-speed mobile in a direction in which the high-speed mobile intends to move.

In operation 660, the power control system according to an exemplary embodiment may radiate the controlled transmission power to the communication base station.

In operation 680, the power control system according to an exemplary embodiment may store data resulting from the control of the transmission power executed based on the moving path of the high-speed mobile. The stored result data may be used to determine the transmission power and the antenna beam pattern of the high-speed mobile.

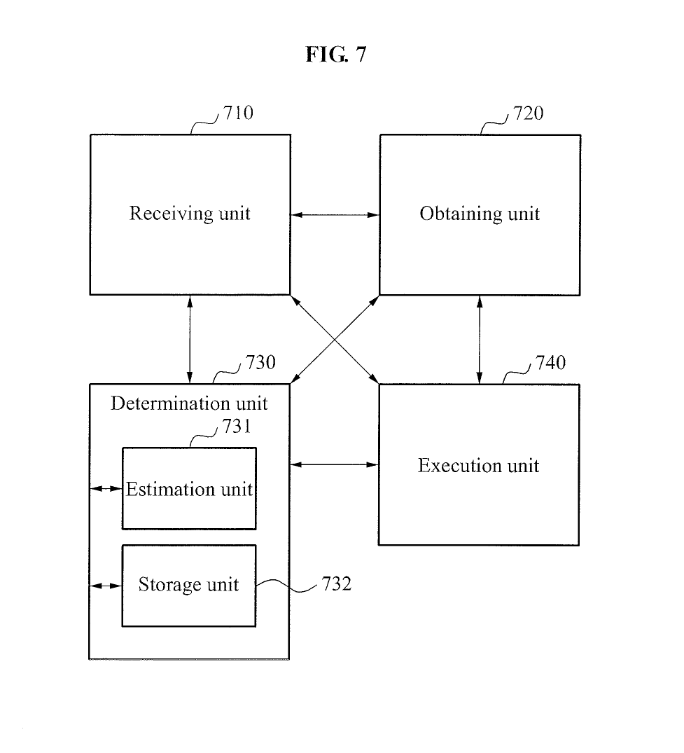

FIG. 7 is a block diagram illustrating a configuration of a handover system for wireless communication of a high-speed mobile according to an exemplary embodiment.

Referring to FIG. 7, the handover system for wireless communication of a high-speed mobile may include a receiving unit 710, an obtaining unit 720, a determination unit 730, and an execution unit 740.

The receiving unit 710 may receive, from a candidate communication base station able to communicate with the high-speed mobile, location information of the candidate communication base station and location information of a neighboring communication base station near the candidate communication base station.

The obtaining unit 720 may obtain current location information and speed information of the high-speed mobile based on GPS satellite information of the high-speed mobile and topographic information around the high-speed mobile.

The determination unit 730 may determine an optimal communication base station among the candidate communication base station and the neighboring communication base station, based on the location information of the candidate communication base station, the location information of the neighboring communication base station, the current location information of the high-speed mobile, and the speed information of the high-speed mobile.

The determination unit 730 may include an estimation unit 731.

The estimation unit 731 may estimate future location information of the high-speed mobile based on the current location information and the speed information of the high-speed mobile.

The determination unit 730 may determine an optimal communication base station among the candidate communication base station and the neighboring communication base station, based on the location information of the candidate communication base station, the location information of the neighboring communication base station, and the future location information of the high-speed mobile.

Also, the determination unit 730 may include a storage unit 732.

The storage unit 732 may store data resulting from the handover executed based on a moving path of the high-speed mobile.

Also, the determination unit 730 may determine an optimal communication base station among the candidate communication base station and the neighboring communication base station based on the result data stored in the storage unit 732.

The execution unit 740 may execute handover to the optimal communication base station.

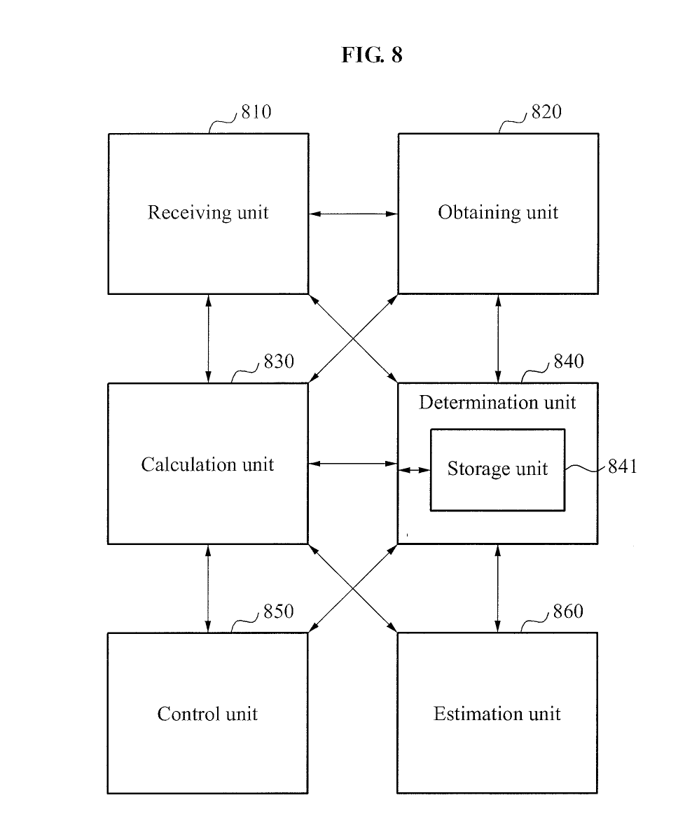

FIG. 8 is a block diagram illustrating a configuration of a power control system for wireless communication of a high-speed mobile according to an exemplary embodiment.

Referring to FIG. 8, the power control system for wireless communication of a high-speed mobile may include a receiving unit 810, an obtaining unit 820, a calculation unit 830, a determination unit 840, a control unit 850, and an estimation unit 860.

The receiving unit 810 may receive, from a communication base station communicating with the high-speed mobile, location information of the communication base station.

The obtaining unit 820 may obtain location information and speed information of the high-speed mobile based on GPS satellite information of the high-speed mobile and topographic information around the high-speed mobile.

The calculation unit 830 may calculate a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile.

The determination unit 840 may determine a transmission power and an antenna beam pattern of the high-speed mobile based on a result of the calculation.

The determination unit 840 may include a storage unit 841.

The storage unit 841 may store data resulting from the control of transmission power executed based on a moving path of the high-speed mobile.

Also, the determination unit 840 may determine a transmission power and an antenna beam pattern of the high-speed mobile based on the result data stored in the storage unit 841.

The control unit 850 may control a transmission power to be radiated to the communication base station based on the determined transmission power and the determined antenna beam pattern.

The estimation unit 860 may estimate a change in the transmission power with the movement of the high-speed mobile using the speed information of the high-speed mobile and the topologic information around the high-speed mobile in a direction in which the high-speed mobile intends to move.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one to or more computer readable recording mediums.

The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

According to exemplary embodiments, there may be provided a method, apparatus, and system for handover and power control for wireless communication of a high-speed mobile using location information and speed information based on a moving path of the high-speed mobile.

According to exemplary embodiments, there may be also provided a method, apparatus, and system for executing handover for wireless communication of a high-speed mobile by estimating future location information of the high-speed mobile.

According to exemplary embodiments, there may be also provided a method, apparatus, and system for using data resulting from handover executed based on a moving path of a high-speed mobile in the handover for wireless communication of the high-speed mobile.

According to exemplary embodiments, there may be also provided a method, apparatus, and system for executing power control for wireless communication of a high-speed mobile by estimating a change in transmission power with the movement of the high-speed mobile.

According to exemplary embodiments, there may be also provided a method, apparatus, and system for using data resulting from power control executed based on a moving path of a high-speed mobile in the power control for wireless communication of the high-speed mobile.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method for handover for wireless communication of a high-speed mobile, the method comprising:
receiving, from a candidate communication base station able to communicate with the high-speed mobile, location information of the candidate communication base station and location information of a neighboring communication base station near the candidate communication base station;
obtaining current location information and speed information of the high-speed mobile based on global positioning system (GPS) satellite information of the high-speed mobile and topographic information around the high-speed mobile;
determining an optimal communication base station among the candidate communication base station and the neighboring communication base station, based on the location information of the candidate communication base station, the location information of the neighboring communication base station, the current location information of the high-speed mobile, and the speed information of the high-speed mobile; and
executing handover to the optimal communication base station.

2. The method of claim 1, wherein the determining of the optimal communication base station comprises:
estimating future location information of the high-speed mobile based on the current location information and the speed information of the high-speed mobile; and
determining the optimal communication base station among the candidate communication base station and the neighboring communication base station, based on the location information of the candidate communication base station, the location information of the neighboring communication base station, and the future location information of the high-speed mobile.

3. The method of claim 1, further comprising:
extracting a candidate communication base station able to communicate with the high-speed mobile among a plurality of communication base stations near the high-speed mobile.

4. The method of claim 3, wherein the extracting of the candidate communication base station comprises estimating the candidate communication base station among the plurality of communication base stations, using the speed information of the high-speed mobile and the topographic information around the high-speed mobile in a direction in which the high-speed mobile intends to move.

5. The method of claim 1, further comprising:
storing data resulting from the handover executed based on a moving path of the high-speed mobile,
wherein the determining of the optimal communication base station further comprises determining the optimal communication base station among the candidate communication base station and the neighboring communication base station based on the result data.

6. A method for power control for wireless communication of a high-speed mobile, the method comprising:
receiving, from a communication base station communicating with the high-speed mobile, location information of the communication base station;
obtaining location information and speed information of the high-speed mobile based on global positioning system (GPS) satellite information of the high-speed mobile and topographic information around the high-speed mobile;
calculating a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile;
determining a transmission power and an antenna beam pattern of the high-speed mobile based on a result of the calculation; and
controlling a transmission power to be radiated to the communication base station based on the determined transmission power and the determined antenna beam pattern.

7. The method of claim 6, further comprising:
estimating a change in the transmission power with the movement of the high-speed mobile using the speed information of the high-speed mobile and the topologic information around the high-speed mobile in a direction in which the high-speed mobile intends to move.

8. The method of claim 6, further comprising:
storing data resulting from the control of the transmission power executed based on a moving path of the high-speed mobile,
wherein the determining further comprises determining the transmission power and the antenna beam pattern of the high-speed mobile based on the result data.

9. The method of claim 6, wherein the determining comprises determining the transmission power and the antenna beam pattern of the high-speed mobile to maintain a constant level of received power being received at the communication base station, and
the received power is dependent on at least one of the location information of the communication base station, the location information of the high-speed mobile, the speed information of the high-speed mobile, and the topologic information around the high-speed mobile.

10. A system for handover for wireless communication of a high-speed mobile, the system comprising:
a receiving unit to receive, from a candidate communication base station able to communicate with the high-speed mobile, location information of the candidate communication base station and location information of a neighboring communication base station near the candidate communication base station;
an obtaining unit to obtain current location information and speed information of the high-speed mobile based on global positioning system (GPS) satellite information of the high-speed mobile and topographic information around the high-speed mobile;
a determination unit to determine an optimal communication base station among the candidate communication base station and the neighboring communication base station, based on the location information of the candidate communication base station, the location information of the neighboring communication base station, the current location information of the high-speed mobile, and the speed information of the high-speed mobile; and
an execution unit to execute handover to the optimal communication base station.

11. The system of claim 10, wherein the determination unit comprises an estimation unit to estimate future location information of the high-speed mobile based on the current location information and the speed information of the high-speed mobile, and
the determination unit determines the optimal communication base station among the candidate communication base station and the neighboring communication base station, based on the location information of the candidate communication base station, the location information of the neighboring communication base station, and the future location information of the high-speed mobile.

12. The system of claim 10, wherein the determination unit further comprises a storage unit to store data resulting from the handover executed based on a moving path of the high-speed mobile, and
the determination unit determines the optimal communication base station among the candidate communication base station and the neighboring communication base station based on the result data stored in the storage unit.

13. A system for power control for wireless communication of a high-speed mobile, the system comprising:
a receiving unit to receive, from a communication base station communicating with the high-speed mobile, location information of the communication base station;
an obtaining unit to obtain location information and speed information of the high-speed mobile based on global positioning system (GPS) satellite information of the high-speed mobile and topographic information around the high-speed mobile;
a calculation unit to calculate a distance between the high-speed mobile and the communication base station and a direction from the high-speed mobile to the communication base station, based on the location information of the communication base station, the location information of the high-speed mobile, the speed information of the high-speed mobile, and the topologic information around the high-speed mobile;
a determination unit to determine a transmission power and an antenna beam pattern of the high-speed mobile based on a result of the calculation; and
a control unit to control a transmission power to be radiated to the communication base station based on the determined transmission power and the determined antenna beam pattern.

14. The system of claim 13, further comprising:
an estimation unit to estimate a change in the transmission power with the movement of the high-speed mobile using the speed information of the high-speed mobile and the topologic information around the high-speed mobile in a direction in which the high-speed mobile intends to move.

15. The system of claim 13, wherein the determination unit further comprises a storage unit to store data resulting from the control of the transmission power executed based on a moving path of the high-speed mobile,
wherein the determination unit determines the transmission power and the antenna beam pattern of the high-speed mobile based on the result data stored in the storage unit.
